(19) United States
(12) Patent Application Publication
(10) Pub. No.: US 2024/0428274 A1
(43) Pub. Date: Dec. 26, 2024

(54) SYSTEM AND METHOD FOR DETERMINING MULTI-PARTY COMMUNICATION ENGAGEMENT

(71) Applicant: VERIZON PATENT AND LICENSING INC., Basking Ridge, NJ (US)

(72) Inventors: Karthick KALIANNAN NEELAMOHAN, Namakkal (IN); Tarun NAGPAL, Bangalore (IN); Kunal SACHDEVA, Kanpur (IN)

(73) Assignee: VERIZON PATENT AND LICENSING INC., Basking Ridge, NJ (US)

(21) Appl. No.: 18/337,694

(22) Filed: Jun. 20, 2023

(51) Int. Cl. G06Q 30/0201; G06F 40/166; G06F 40/205; G06F 40/284

(52) U.S. Cl. CPC G06Q 30/0201; G06F 40/166; G06F 40/205; G06F 40/284

(57) ABSTRACT

A multi-party communications (MPC) analysis framework allows for the determination of participant engagement and MPC insights. In some embodiments, the MPC analysis framework allows for the determination of an engagement score indicating a level of engagement of participants to the MPC. In some embodiments, the MPC analysis framework allows for the identification of relevant participant metrics with respect to the MPC. In some embodiments, the MPC analysis framework allows for the generation of visual representations illustrating core concepts discussed during the MPC.

### BACKGROUND

Interpersonal and multi-party communications (MPCs) such as conferences, meetings, and calls are the cornerstone of enterprise development and growth. However, constant communication can be duplicative and detrimental to achieving enterprise goals. Gauging participant engagement during an MPC is essential for streamlining enterprise processes and reducing effort duplication. However, current methods for gauging engagement rely mainly on barebones statistics open to differing interpretations.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating an example environment within which the systems and methods disclosed herein could be implemented according to an embodiment.

FIG. 2 is a block diagram illustrating components of an MPC analysis system according to an embodiment.

FIG. 3 is a flow diagram illustrating a method for generating MPC insights according to an embodiment.

FIG. 4 is a flow diagram illustrating a method for generating an engagement score model according to an embodiment.

FIG. 5 is a flow diagram illustrating a method for generating an MPC keyword illustration according to an embodiment.

FIG. 6 is a flow diagram illustrating a method for training an MPC action items model according to an embodiment.

FIG. 7 illustrates a non-limiting example event timeline according to an embodiment.

FIG. 8 illustrates a non-limiting example of a visual representation of MPC keywords according to an embodiment.

FIG. 9 is a block diagram of a device according to an embodiment.

### DETAILED DESCRIPTION

The present disclosure provides for an MPC analysis framework to determine participant engagement and provide MPC insights. In some embodiments, the MPC analysis framework allows for identification of a type of the MPC. In some embodiments, the MPC analysis framework allows for the determination of an engagement score indicating a level of engagement of participants to the MPC. In some embodiments, the MPC analysis framework allows for the determination of action items related to the content discussed during the MPC. In some embodiments, the MPC analysis framework allows for the identification of relevant participant metrics with respect to the MPC. In some embodiments, the MPC analysis framework allows for the generation of visual representations illustrating core concepts discussed during the MPC.

In some aspects, the techniques described herein relate to a method for generating an engagement score related to an MPC. In some aspects, the method includes receiving, from an application on a user equipment (UE) of a user, a request to provide an engagement score corresponding to a multi-party communication (MPC). Then, in some aspects, the method includes obtaining MPC data corresponding to the MPC, the MPC data including general MPC data and participant-specific MPC data and determining the engagement score by applying a trained engagement score model to the general MPC data and the participant-specific MPC data. In some aspects, the method further includes transmitting, to the UE, the engagement score to be displayed to the user through the application.

In some aspects, the techniques described herein relate to a non-transitory computer-readable storage medium for storing instructions executable by a processor, the instructions including receiving, from an application on a user equipment (UE) of a user, a request to provide an engagement score corresponding to a multi-party communication (MPC). Then, in some aspects, the instructions include obtaining MPC data corresponding to the MPC, the MPC data including general MPC data and participant-specific MPC data and determining the engagement score by applying a trained engagement score model to the general MPC data and the participant-specific MPC data. In some aspects, the instructions further include transmitting, to the UE, the engagement score to be displayed to the user through the application.

In some aspects, the techniques described herein relate to a device comprising a processor configured to determine an engagement score related to an MPC. In some aspects, the processor is configured to receive, from an application on a user equipment (UE) of a user, a request to provide an engagement score corresponding to a multi-party communication (MPC). In some aspects, the processor is configured to obtain MPC data corresponding to the MPC, the MPC data including general MPC data and participant-specific MPC data; and determine the engagement score by applying a trained engagement score model to the general MPC data and the participant-specific MPC data. In some aspects, the processor is further configured to transmit, to the UE, the engagement score to be displayed to the user through the application.

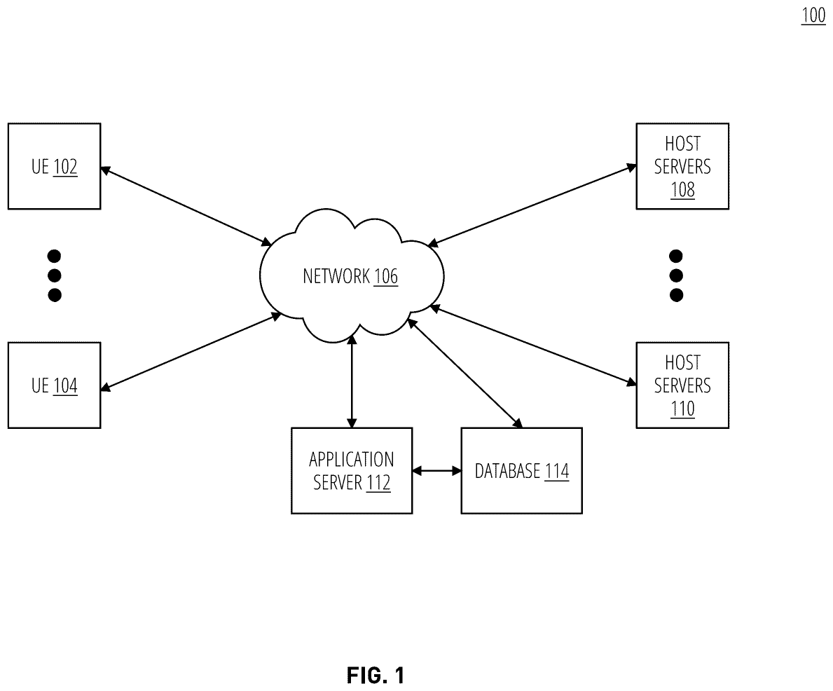

FIG. 1 is a block diagram illustrating an example environment within which the systems and methods disclosed herein could be implemented according to an embodiment.

FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 can include user equipment (UE) 102-104, network 106, host servers 108-110, application server 112, and database 114.

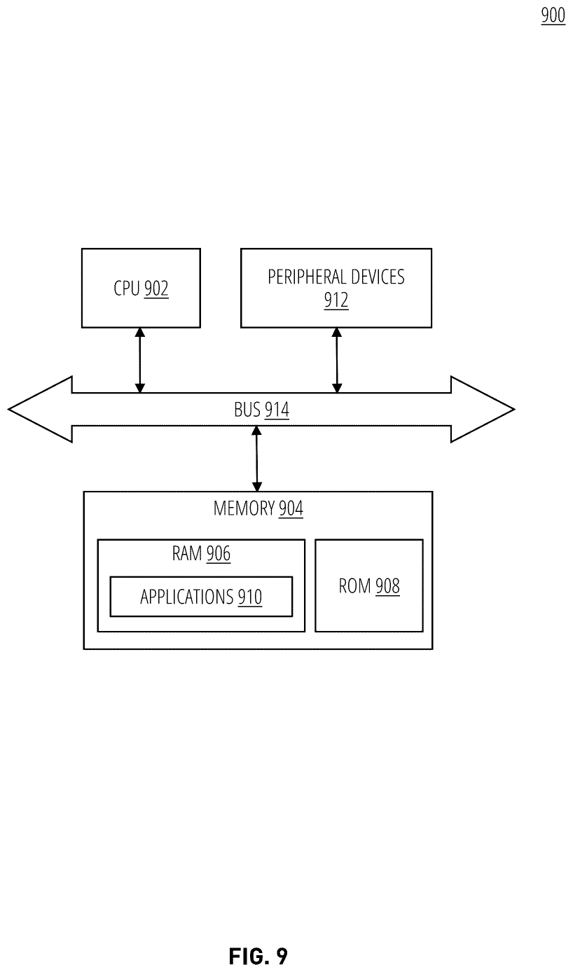

In the illustrated embodiment, UE 102-104 can communicate with host servers 108-110 and application server 112 via network 106. In some embodiments, UE 102-104 can include virtually any computing device capable of communicating with other UE, devices, or servers over a network, such as network 106. In some embodiments, UE 102-104 may be capable of sending or receiving signals, such as via a wired or wireless network, or may be capable of processing or storing signals, such as in memory as physical memory states. As examples, UE 102-104 can include mobile phones, smart devices, tablets, laptops, sensors, IoT devices, autonomous machines, unmanned aerial vehicles (UAVs), wired devices, wireless handsets, and any other devices equipped with a cellular or wireless or wired transceiver, whether portable or non-portable. In some embodiments, UE 102-104 can also be described generally as client devices. In some embodiments, UE 102-104 can be devices 900 as described with respect to FIG. 9.

In some embodiments, UE 102-104 can include at least one client application or program that is configured to communicate with a host sever, such as, host servers 108-110 or application server 112. In some embodiments, the client application can include a capability to provide and receive textual content, graphical content, audio content, and the like. In some embodiments, the client application can further provide information that identifies itself and/or the UE including a type, capability, name, and the like.

According to some embodiments, network 106 can be configured to couple UE 102-104, host servers 108-110, and/or application server 112. In some embodiments, network 106 can be a wired network, a wireless network, or a combination thereof. In some embodiments, network 106 is enabled to employ any form of computer readable media or network for communicating information from one electronic device to another. In some embodiments, network 106 can include the Internet, a local area network (LAN), a wireless LAN, a wide area network (WAN), a mobile edge computing (MEC) network, a private network, a cellular network, and the like. According to some embodiments, a “network” should be understood to refer to a network that may couple devices so that communications may be exchanged (e.g., between a server and a client device or between servers) including between wireless devices coupled via a wireless network, for example. In some embodiments, a network can also include mass storage or other forms of computer or machine readable media (e.g., database 114), for example.

In some embodiments, network 106 can include an access network and/or core network (not shown) of a mobile network. In general, the access network can include at least one base station that is communicatively coupled to the core network and coupled to zero or more UE 102-104. In some embodiments, the access network can comprise a cellular access network, for example, a fifth-generation (5G) network or a fourth-generation (4G) network. In one embodiment, the access network can comprise a NextGen Radio Access Network (NG-RAN), which can be communicatively coupled to UE 102-104. In an embodiment, the access network can include a plurality of base stations (e.g., eNodeB (cNB), gNodeB (gNB)) communicatively connected to UE 102-104 via an air interface. In some embodiments, the air interface can comprise a New Radio (NR) air interface. For example, in some embodiments, in a 5G network, UE 102-104, host servers 108-110, and/or application server 112 can be communicatively coupled to each other and to other devices. And, in some embodiments, for example, such coupling can be via Wi-Fi functionality, Bluetooth, or other forms of spectrum technologies, and the like.

In some embodiments, the access network and/or core network may be owned and/or operated by a service provider or an NO and provides wireless connectivity to UE 102-104 via the access network. In some embodiments, the core network can be communicatively coupled to a data network. In some embodiments, the data network can include one or more host servers 108-110. In some embodiments, network 106 can include one or more network elements. In some embodiments, network elements may be physical elements such as router, servers and switches or may be virtual Network Functions (NFs) implemented on physical elements.

According to some embodiments, host servers 108-110 and/or application server 112 can be capable of sending or receiving signals, such as via a wired or wireless network (e.g., network 106), or may be capable of processing or storing signals, such as in memory as physical memory states. In some embodiments, host servers 108-110, application server 112 can store, obtain, retrieve, transform, or provide content and/or content data in any form, known or to be known, without departing from the present disclosure.

As used herein, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

According to some embodiments, devices capable of operating as a server (e.g., host servers 108-110 or application server 112) may include, as examples, dedicated rack-mounted servers, desktop computers, laptop computers, set top boxes, integrated devices combining various features, such as two or more features of the foregoing devices, or the like. In some embodiments, host servers 108-110 and/or application server 112 can be devices 900 as described with respect to FIG. 9.

Moreover, although FIG. 1 illustrates host servers 108-110 and application server 112 as single computing devices, respectively, the disclosure is not so limited. For example, one or more functions of host server host servers 108-110 and/or application server 112 can be distributed across one or more distinct computing devices.

In some embodiments, host servers 108-110 and/or application server 112 can implement devices or engines that are configured to provide a variety of services that include, but are not limited to, email services, instant messaging (IM) services, streaming and/or downloading media services, search services, photo services, web services, social networking services, news services, third-party services, audio services, video services, advertising services, mobile application services, NLP services, or the like. In some embodiments, in addition to application server 112, host servers 108-110 can also be referred to as application servers. In some embodiments, application servers can provide the foregoing services to a user upon the user being authenticated, verified, or identified by the service. In some embodiments, users can access services provided by host servers 108-110 and/or application server 112 via the network 106 using UE 102-104. In some embodiments, application server 112 can implement, in part or in its entirety, an insights engine (e.g., MPC analysis engine 202).

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), web conferencing applications (e.g., BlueJeans®, Zoom®, Skype®, and the like), search applications (e.g., Yahoo!® Search), and the like, can be hosted by host servers 108-110 and/or application server 112. Thus, in some embodiments, application server 112, for example, can store various types of applications and application related information including application data and user profile information (e.g., identifying and behavioral information associated with a user).

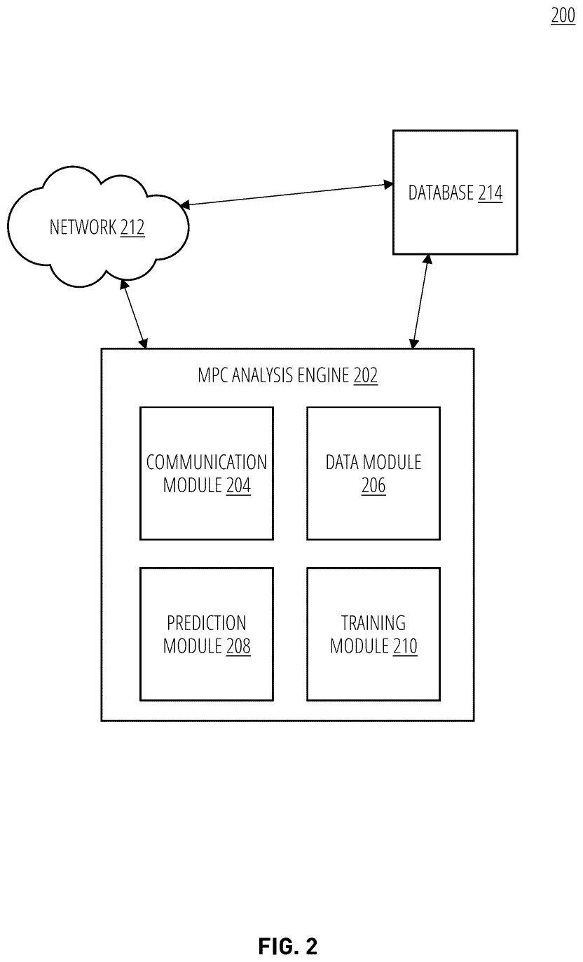

FIG. 2 is a block diagram illustrating components of an MPC analysis system according to an embodiment.

According to some embodiments, insights system 200 can include MPC analysis engine 202, network 212, and database 214. In some embodiments, MPC analysis engine 202 can be a special purpose machine or processor and could be hosted by a cloud server (e.g., cloud web services server(s)), messaging server, application server, content server, social networking server, web server, search server, content provider, third party server, user's computing device, and the like, or any combination thereof. In some embodiments, MPC analysis engine 202 can be implemented, in part or in its entirety, on application server 112 as discussed in relation to FIG. 1.

According to some embodiments, MPC analysis engine 202 can be a stand-alone application that executes on a device (e.g., device 900 from FIG. 9). In some embodiments, MPC analysis engine 202 can function as an application installed on the device, and in some embodiments, such application can be a web-based application accessed by the device (e.g., UE 102-104) over a network (e.g., network 106). In some embodiments, portions of the MPC analysis engine 202 can function as an application installed on the device and some other portions can be cloud-based or web-based applications accessed by the computing device over a network (e.g., network 212), where the several portions of the MPC analysis engine 202 exchange information over the network (e.g., between host servers 108-110 and/or application server 112). In some embodiments, the MPC analysis engine 202 can be installed as an augmenting script, program or application (e.g., a plug-in or extension) to another application or portable data structure.

In some embodiments, the database 214 can be any type of database or memory, and can be associated with a host server or an application server on a network or a computing device. In some embodiments, portions of database 214 can be included in database 114 or be internal to a server or other device.

In some embodiments, a database 214 can include data and/or metadata associated with users, devices, and applications. In some embodiments, such information can be stored and indexed in the database 214 independently and/or as a linked or associated dataset (e.g., using unique identifiers). According to some embodiments, database 214 can store data and metadata associated with messages, images, videos, text, documents, items and services from an assortment of media, applications and/or service providers and/or platforms, and the like. Accordingly, any other type of known or to be known attribute or feature associated with a record, request, data item, media item, website, application, communication, and/or its transmission over a network (e.g., network traffic), content included therein, or some combination thereof, can be saved as part of the data/metadata in database 214.

In some embodiments, database 214 can include MPC data. In some embodiments, MPC data can include audio or video recordings. In some embodiments, recordings included in MPC data can be in any format, known or to be known, without departing from the scope of the present disclosure. In some embodiments, recordings included in MPC data can have associated recording metadata (e.g., date, time, length, size, author, type, format, etc.). In some embodiments, MPC data can be text transcripts of audio or video recordings.

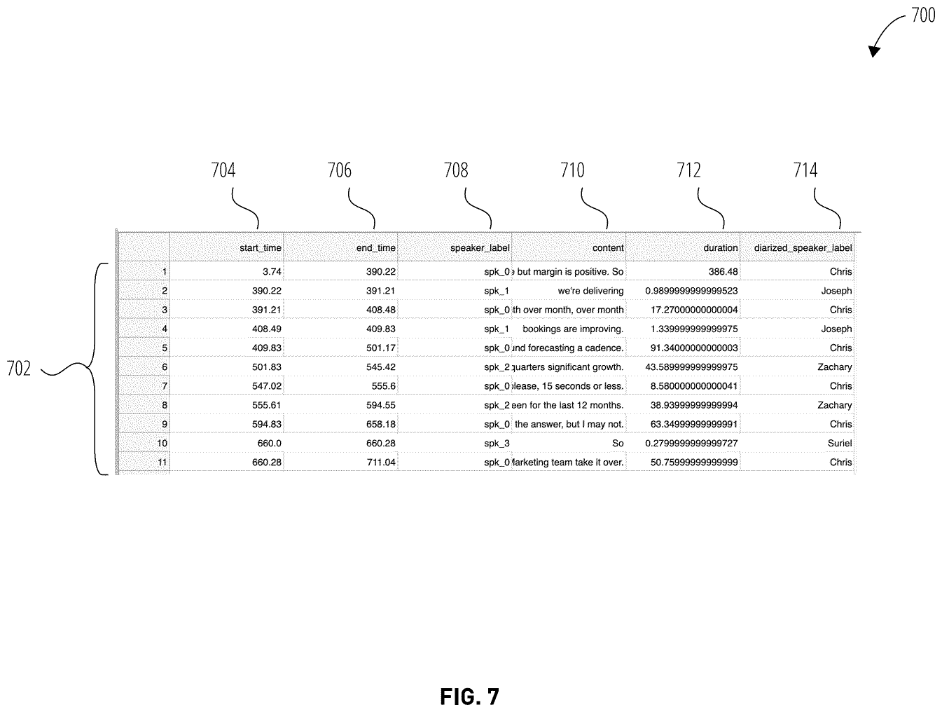

In some embodiments, MPC data can include event timelines corresponding to the MPC recordings. A non-limiting example embodiment of an event timeline is illustrated in FIG. 7. In some embodiments, when the MPC data includes a video recording, the MPC data can include a plurality of discrete video frames or sequence of frames and/or associated audio for each frame or sequence. In some embodiments, MPC data can correlate events with discrete video frames and/or audio snippets.

In some embodiments, MPC data can include speaker separated data (e.g., snippets of audio, video, text, or a combination thereof attributed to individual speakers). In some of those embodiments, MPC data can include one or more discrete audio snippets of the MPC where each audio snippet has an associated speaker or timestamp (e.g., as metadata). In some embodiments, MPC data can include discrete text strings from a chat conversation among two or more speakers. In some embodiments, each discrete text string can correspond to an input or contribution by a speaker or participant. In some embodiments, each discrete text string can have an associated speaker or timestamp (e.g., as metadata).

In some embodiments, MPC data can include annotated MPC data associated with an MPC, MPC recording, event timeline, or a combination thereof. In some embodiments, annotated MPC data can include MPC data that has been labeled or otherwise annotated either manually by a human or automatically by a labeling algorithm. For example, in some embodiments, annotated MPC data can include an MPC summary corresponding to an MPC. In some embodiments, the MPC summary can be based on at least one of manual notes prepared by a human, the MPC recording, and/or an event timeline associated with the meeting. In some embodiments, annotated MPC data can include one or more action items, decisions, notes, and/or follow-up items associated with the MPC. In some embodiments, annotated MPC data can include one or more types of MPCs associated with an MPC and one or more engagement scores corresponding to the one or more types of MPCs. In some embodiments, the annotated MPC data can include an overall engagement score associated with the MPC.

According to some embodiments, network 212 can be any type of network such as, but not limited to, a wireless network, a local area network (LAN), wide area network (WAN), the Internet, or a combination thereof. In some embodiments, network 212 can facilitate connectivity of the MPC analysis engine 202, and the database 214. Indeed, as illustrated in FIG. 2, the MPC analysis engine 202 and database 214 can be directly connected by any known or to be known method of connecting and/or enabling communication between such devices and resources. In some embodiments, network 212 can include some or all the elements of network 106 as discussed in relation to FIG. 1.

The principal processor, server, or combination of devices that comprise hardware programmed in accordance with the special purpose functions herein is referred to for convenience as MPC analysis engine 202, and includes communication module 204, data module 206, prediction module 208, and training module 210. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

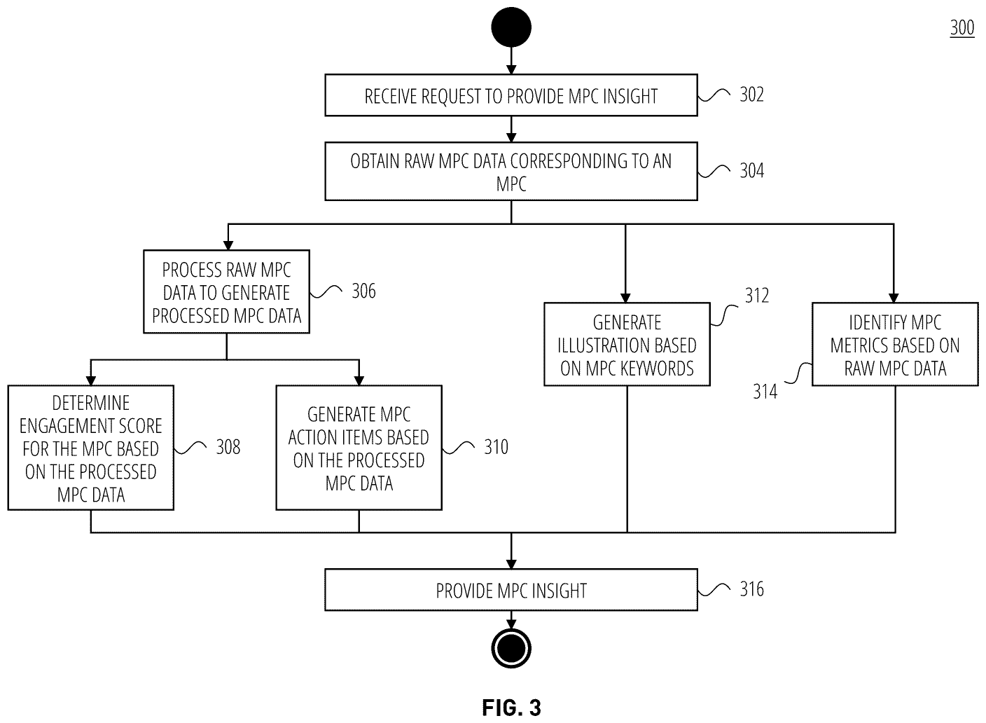

FIG. 3 is a flow diagram illustrating a method for generating MPC insights according to an embodiment.

According to some embodiments, method 300 can be performed by MPC analysis engine 202. In some embodiments, Steps 302 and 316 can be performed by communication module 204; Steps 304, 306, 312, and 314 can be performed by data module 206; and Steps 308 and 310 can be performed by prediction module 208.

In Step 302, method 300 can include receiving a request to provide one or more MPC insights related to an MPC. For example, in some embodiments, the MPC insights can include an engagement score indicating a level of engagement of participants to the MPC. In some embodiments, the MPC insights can include relevant participant metrics related to the MPC. In some embodiments, the MPC insights can include a visual representation illustrating core concepts discussed during the MPC.

In Step 304, method 300 can include obtaining raw MPC data corresponding to an MPC. In some embodiments, the raw MPC data can include a video and/or audio component. In some embodiments, the raw MPC data can also include a text component (e.g., a transcript) of the audio or video. In some embodiments, raw MPC data can include an event timeline (e.g., event timeline 700) associated with the MPC.

In some embodiments, the raw MPC data can include general and participant-specific MPC data and metadata. In some embodiments, general MPC data/metadata can include the number of participants, dates and times associated with the MPC (e.g., start time/date, end time/date), an overall duration or length, and a ratio or number of invited participants versus actual participants. In some embodiments, participant-specific MPC data/metadata can include inbound/outbound audio and/or video timing, inbound/outbound content timing, total inbound/outbound timing, total duration of participation, percentage of participation from overall MPC length, communications quality, and geographical location.

In Step 306, method 300 can include processing the raw MPC data to generate processed MPC data. In some embodiments, the processed MPC data includes the general and/or participant-specific MPC data and/or metadata extracted from the raw MPC data. In some embodiments, processing the raw MPC data can include cleaning the data (e.g., address missing values, remove duplicates, etc.), normalizing or scaling the data, and augmenting the data.

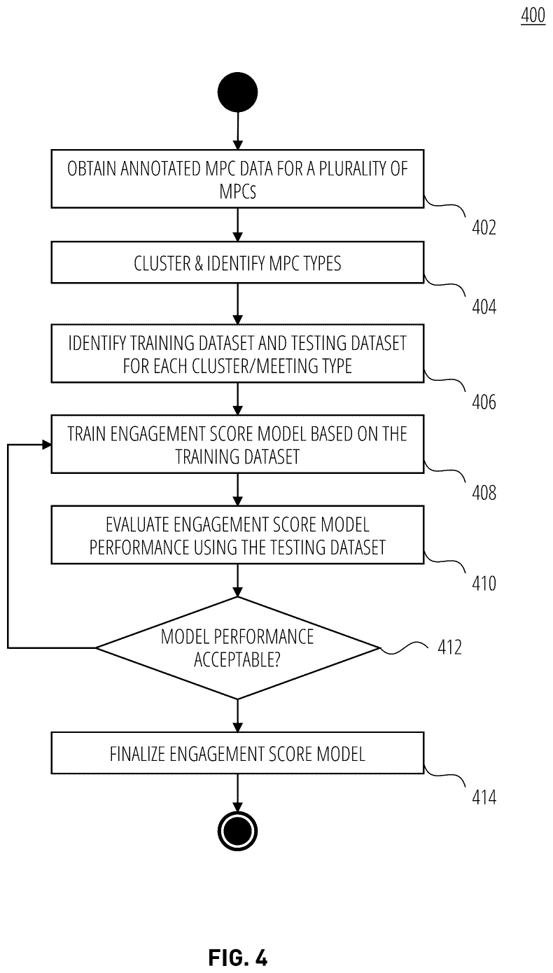

In Step 308, method 300 can include determining an MPC engagement score based on the processed MPC data. In some embodiments, the MPC engagement score can be determined by applying a trained engagement score model to the processed MPC data. In some embodiments, the engagement score can be an integer from 0 to 1 with ideal participant behavior being 1 and least ideal participant behavior being 0. In some embodiments, the trained engagement score model can be generated as described in relation to FIG. 4.

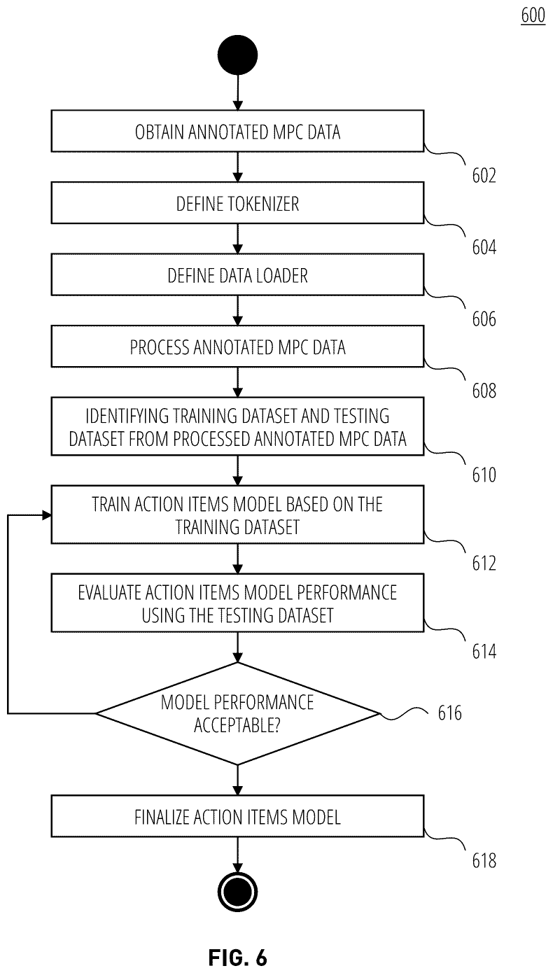

In Step 310, method 300 can include determining MPC action items (or follow-up items used interchangeably), decisions, and/or notes related to the content of the MPC. For example, in some embodiments, an action item can be an action to be performed with respect to content discussed during the MPC (e.g., schedule a new meeting, follow up with a participant or other third party, send a summary of the MPC to a third party). As another example, in some embodiments, a decision can be a course of action with respect to a point of discussion among the participants during the MPC (e.g., sign a contract being discussed, change a feature of a product, publish a work of authorship, etc.). In some embodiments, the action items can be determined by applying a trained action items model to the processed MPC data. In some embodiments, the trained engagement score model can be generated as described in relation to FIG. 6.

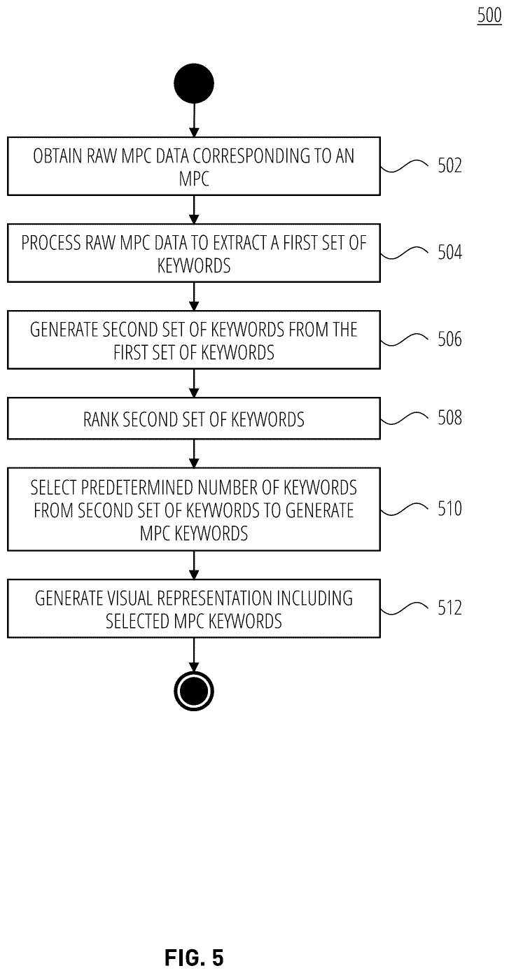

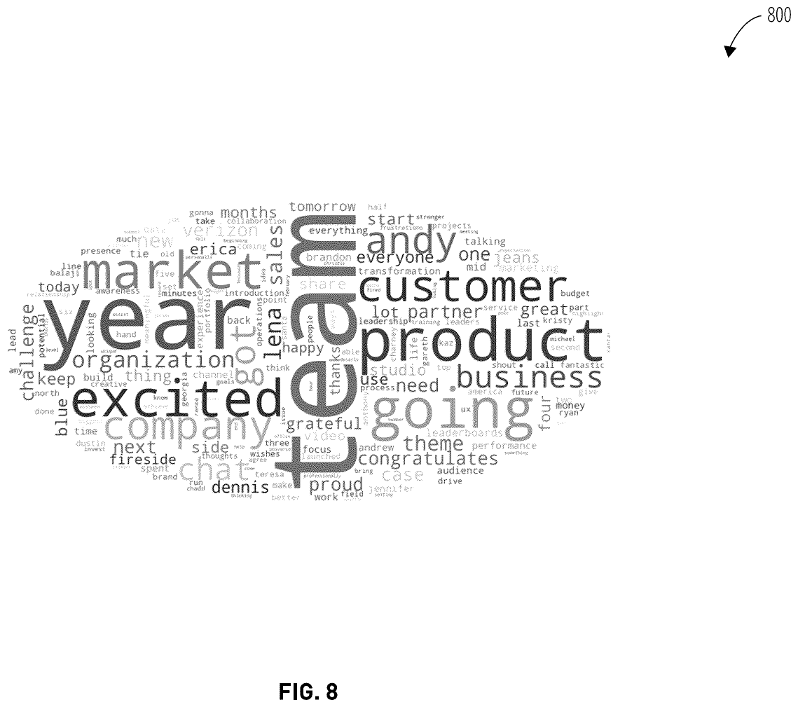

In Step 312, method 300 can include identifying MPC keywords based on the raw MPC data and generating a visual representation depicting MPC keywords where each word is sized according to the frequency of use (sometimes known as a word cloud). A non-limiting example method for generating the visual representation is discussed with respect to FIG. 5. FIG. 8 illustrates a non-limiting example of a visual representation 800 of MPC keywords.

In Step 314, method 300 can include identifying MPC metrics based on raw MPC data. In some embodiments, the MPC metrics can include a number of attendees, a number of moderators, a length of the MPC, or any other quantifiable metric corresponding to the participants of the MPC and the content discussed during the MPC. In some embodiments, the MPC metrics can be extracted from the MPC metadata.

In Step 316, method 300 can include providing or otherwise transmitting the MPC insights based on the request received from UE. In some embodiments, the MPC insights can include at least one of the engagement score, the visual representation, and the MPC metrics.

FIG. 4 is a flow diagram illustrating a method for generating an engagement score model according to an embodiment.

In Step 402, method 400 can include obtaining annotated MPC data corresponding to a plurality of MPCs. In some embodiments, the data module 206 of insights system 200 can retrieve the annotated MPC data from a database (e.g., database 214). In some embodiments, the annotated MPC data can include a video component, an audio component, and a text component (e.g., a transcript). In some embodiments, the annotated MPC data can include general and participant-specific MPC data and metadata. In some embodiments, annotated MPC data can be MPC data with annotations provided by human reviewers. In some embodiments, annotated MPC data can include off-the-shelf datasets.

In Step 404, method 400 can include clustering the MPCs based on the annotated MPC data. In some embodiments, data module 206 can segment and cluster the MPCs into a clusters based on the general and participant-specific MPC data and metadata. For example, in some embodiments, the MPCs can be clustered based on the percentage of attendees percent (e.g., when compared to the total number of invitees), the percentage of attendees attending in the same country (e.g., co-geographical country attendees), the percentage of attendees attending in the same city (e.g., co-geographical city attendees), duration, ratio of audio inbound versus outbound, ratio of video inbound versus outbound, ratio of total inbound versus outbound, and number of attendees.

In some embodiments, each cluster represents a type of MPC. For example, in some embodiments, a type of MPC can be described as “short small high interactive ideal presence” indicating an MPC with a short duration, a small number of participants, highly interactive participants (e.g., in terms of speaking time or appearing on video), and with ideal presence (e.g., in terms of the number of invitees attending). As another example, in some embodiments, a type of MPC can be described as “long large less interactive with dropouts” indicating an MPC with a long duration, a large number of participants, less interactive participants (e.g., in terms of speaking time or appearing on video), and with dropouts (e.g., participants that abandon the MPC before it is concluded).

In some embodiments, clustering can be achieved using a clustering algorithm such as K-means clustering or any other suitable clustering algorithm. In some embodiments, the number of cluster can be predetermined (e.g., 4, 6, 8, 12, etc.).

In Step 406, method 400 can include identifying a training dataset and a testing dataset from the clustered MPCs. In some embodiments, the data module 206 can select the training and testing datasets through stratified sampling. In some embodiments, each of the training dataset and the testing dataset can represent the cluster/MPC types proportionately. In some embodiments, the training datasets and testing datasets can be split based on specific MPC data or features. For example, in some embodiments, the datasets can be selected on a delay duration (e.g., of a participant), events/interactions with an application in a UE by a user during the MPC, the duration of stay of participants during the MPC, audio inbound duration, total inbound duration, or talk duration.

In some embodiments, the training dataset can be used to train the engagement score model while the testing dataset can be used to evaluate the model's performance. In some embodiments, a third dataset—a validation dataset—can also be used during training to tune hyperparameters and make decisions on the training process.

In Step 408, method 400 can include training the engagement score model. In some embodiments, the training process can be performed by training module 210. In some embodiments, the engagement score model can be a multi-label classifier. In some embodiments, the engagement score model can be a regression-based model.

In some embodiments, the engagement score model can predict a plurality of scores corresponding to a plurality of categories where the categories correspond to MPC data or features. In some embodiments, for a given category the distribution of scores can be determined and segmented into buckets (e.g., best (value 1)=top 2%, worst (value 0)=bottom 2%, and middle (value 0.5)=between 49% and 51%). In some embodiments, the overall engagement score for a given MPC can be the average of the scores of the categories. In some embodiments, during training, the engagement score model can predict scores across all categories and clusters and the model is updated based on the difference to the pre-ascribed annotations or labels of the annotated MPC data.

In some embodiments, training the engagement score model can include a training technique such as binary relevance (e.g., treating each label as a separate single-class classification), classifier chains (e.g., the labels are trained sequentially and subsequent labels take into account the output of a prior label), or label powerset (e.g., all the labels are treated as a single label). In some embodiments, the training can be repeated until the model's performance on the training dataset or a validation dataset stabilizes or stops improving.

In Step 410, method 400 can include evaluating the engagement score model's performance using the testing dataset. In some embodiments, training module 210 can evaluate the model's performance based on target performance metrics such as accuracy, precision, recall, etc.

In Step 412, method 400 can include determining whether the engagement score model's performance is acceptable based on the results of the model's evaluation in Step 410. In some embodiments, if training module 210 determines that the model's performance is acceptable, then training module 210 finalizes the model in Step 414. If the model's performance is not acceptable then training module 210 repeats some or all of the training process. In some embodiments, the result of Step 414 is a trained engagement score model.

FIG. 5 is a flow diagram illustrating a method for generating an MPC keyword illustration according to an embodiment.

According to some embodiments, method 500 can be performed by MPC analysis engine 202. In some embodiments, Steps 502, 504, 510, and 512 can be performed by data module 206 and Steps 506-508, can be performed by prediction module 208, each in communication with the communication module 204 and the training module 210.

In Step 502, method 500 can include obtaining raw MPC data corresponding to an MPC. In some embodiments, the raw MPC data can include a video and/or audio component. In some embodiments, the raw MPC data can also include a text component (e.g., a transcript) of the audio or video. In some embodiments, raw MPC data can include an event timeline (e.g., event timeline 700) associated with the MPC.

In Step 504, method 500 can include processing text component of the raw MPC data to extract a first set of keywords. In some embodiments, processing the text component can include parsing the text component of the raw MPC data and generating the first set of keywords. In some embodiments, method 500 can include including removing all non-nouns and non-verbs. In some embodiments, the result of Step 504 is a set of all keywords (e.g., nouns and verbs) with associated frequencies (e.g., times the word appears in the transcript).

In Step 506, method 500 can include generating a second set of keywords as a subset of the first set of keywords by applying a trained keyword model to the first set of keywords. In some embodiments, the trained keyword model can be applied directly to the text component of the raw MPC data. In some embodiments, the trained keyword model can be a machine learning model including a transformer-based architecture (e.g., KeyBERT). In some embodiments, the second set of keywords can be identified by applying a keyword tool such as GENSIM to the raw MPC data to obtain the MPC keywords.

In Step 508, method 500 can include ranking the second set of keywords based on the associated keyword frequencies. In some embodiments, the second set of keywords can be ranked from most frequent to least frequent.

In Step 510, method 500 can include selecting a predetermined number of keywords from the ranked second set of keywords to generate MPC keywords. In some embodiments, the predetermined number of keywords is arbitrarily selected (e.g., top 100, middle 10).

In Step 512, method 500 can include generating a visual representation illustrating core concepts discussed during the MPC based on the selected MPC keywords from Step 510. In some embodiments, the visual representation illustrates each selected MPC keyword. In some embodiments, each illustrated MPC keyword has a dimension or size as percentage of the overall illustration that corresponds to the frequency associated with the keyword and is relative to the other keywords. FIG. 8 illustrates a non-limiting example of a visual representation 800 of selected MPC keywords. In the non-limiting example illustrated in FIG. 8, the example keyword “team” is shown larger than the example keyword “company” to represent that the keyword “team” is used more often than the keyword “company.” While FIG. 8 illustrates a plurality of words, visual representation 800 can be generated as a static or interactive image and thus the number and sizing of any elements therein (including words) is non-limiting.

FIG. 6 is a flow diagram illustrating a method for training an MPC action items model according to an embodiment.

In Step 602, method 600 can include obtaining MPC data corresponding to an MPC. In some embodiments, MPC data can be annotated MPC data. In some embodiments, the data module 206 of insights system 200 can retrieve the annotated MPC data from a database (e.g., database 214).

In some embodiments, annotated MPC data can be specific to the action items model being trained. In some embodiments, annotated MPC data can be MPC data with annotations provided by human reviewers. In some embodiments, annotated MPC data can include off-the-shelf datasets. For example, in some embodiments, annotated MPC data used for training a summarization model can include off-the-shelf datasets such as the AMI Meeting Corpus, the DialogSUM dataset, the XSUMM dataset, and the SAMSUM dataset. As another example, In some embodiments, annotated MPC data used for training a tone/style transfer model can include off-the-shelf datasets such as the XFORMAL dataset and the Politeness5 dataset. In some embodiments, annotated MPC data can include data from publicly available social media datasets (e.g., Twitter®, Reddit®).

In Step 604, method 600 can include defining a tokenizer for the action items model being trained. In some embodiments, the tokenizer can convert MPC data or annotated MPC data into a data format suitable for training a machine learning (ML) model such as the action items model. In some embodiments, a tokenizer converts text data into numerical data. In some embodiments, the training module 210 of insights system 200 can select and implement a tokenizer based on the type of action items model being trained. For example, in some embodiments, to train a Bidirectional Auto-Regressive Transformers (BART) or Bidirectional Encoder Representations from Transformers (BERT) architecture-based model, training module 210 can implement the WordPiece tokenizer. In some embodiments, the tokenizer can be any tokenizer used for training BART or BERT architecture-based models.

In Step 606, method 600 can include defining a data loader. In some embodiments, the data module 206 can implement the data loader to manage the annotated MPC data as it is processed and passed to the action items model during training by the training module 210. In some embodiments, a data loader can be an off-the-shelf data loader such as the PyTorch DataLoader or the TensorFlow® data loader.

In Step 608, method 600 can include processing the annotated MPC data in preparation for training the action items model. In some embodiments, Step 608 can be performed by data module 206. In some embodiments, processing the annotated MPC data can include cleaning the data (e.g., address missing values, remove duplicates, etc.), normalizing or scaling the data, and augmenting the data. In some embodiments, the output of Step 608 is processed annotated MPC data.

In Step 610, method 600 can include identifying a training dataset and a testing dataset from the processed annotated MPC data. In some embodiments, the training dataset can be used to train the model while the testing dataset can be used to evaluate the model's performance. In some embodiments, a third dataset—a validation dataset—can also be used during training to tune hyperparameters and make decisions on the training process. In some embodiments, the processed annotated MPC data can be split by the data module 206 based on predetermined ratios (e.g., 80% as training data, 20% as testing data). In some embodiments, data module 206 can shuffle or randomize the processed annotated MPC data prior to identifying the training and testing datasets.

In Step 612, method 600 can include training the action items model. In some embodiments, the action items model can be an ML model including a transformer-based architecture such as the BERT architecture. In some embodiments, the training process can be performed by training module 210. As noted above, in some embodiments, the action items model can be the command recognition model, the summarization model, and the tone/style transfer model. In some embodiments, training the action items model can include initializing the model (e.g., by assigning small, random values to the model's weights or by using pre-trained weights); tokenizing then data in the training dataset using the tokenizer defined in Step 604; masking some of the tokens at random; making predictions for the masked tokens; calculating a loss based on the actual values of the removed tokens; and updating the models parameters (e.g., weights). In some embodiments, these operations can be repeated until the model's performance on the training dataset or a validation dataset stabilizes or stops improving.

In Step 614, method 600 can include evaluating the action items model's performance using the testing dataset. In some embodiments, training module 210 can evaluate the model's performance by comparing the model's performance to a set of predetermined metrics for accuracy, precision, and/or recall.

In Step 616, method 600 can include determining whether the action items model's performance is acceptable based on the results of the model's evaluation in Step 614. In some embodiments, if training module 210 determines that the model's performance is acceptable, then training module 210 finalizes the model in Step 618. If the model's performance is not acceptable then training module 210 repeats some or all of the training process. In some embodiments, the result of Step 618 is a trained action items model.

FIG. 7 illustrates a non-limiting example event timeline according to an embodiment.

In some embodiments, an event timeline 700 can include a one or more events 702 and event data (704-714) for each event 702. In some embodiments, event data can include a start time 704, an end time 706, a duration 712, a content 710, a speaker label 708, or a diarized speaker label 714 indicating a speaker or participant associated with the speaker label 708.

In some embodiments, for a given event 702, content 710 can include an input or contribution by the corresponding speaker or participant (e.g., as denoted by speaker label 708 or content 710). In some embodiments, as shown in FIG. 7, the contribution can be spoken words by the speaker. In some embodiments, the contribution can be a gesture or expression by the speaker and the content can be a description of the contribution. In some embodiments, the contribution can be a string of text entered into a chat. In some embodiments, the contribution can be a digital item (e.g., emoji, picture, video, audio, presentation, document). In some of those embodiments, the content 710 can include a description of the contribution (e.g., “spk_0/Chris has sent a smiling emoji”).

FIG. 9 is a block diagram of a device according to an embodiment.

As illustrated, the device 900 can include a processor or central processing unit (CPU) such as CPU 902 in communication with a memory 904 via a bus 914. Device 900 can also include one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 can comprise a general-purpose CPU. The CPU 902 can comprise a single-core or multiple-core CPU. The CPU 902 can comprise a system-on-a-chip (SoC) or a similar embedded system. In some embodiments, a graphics processing unit (GPU) can be used in place of, or in combination with, a CPU 902. Memory 904 can comprise a non-transitory memory system including a dynamic random-access memory (DRAM), static random-access memory (SRAM), Flash (e.g., NAND Flash), or combinations thereof. In one embodiment, the bus 914 can comprise a Peripheral Component Interconnect Express (PCIe) bus. In some embodiments, bus 914 can comprise multiple busses instead of a single bus.

Memory 904 illustrates an example of non-transitory computer storage media for the storage of information such as computer-readable instructions, data structures, program modules, or other data. Memory 904 can store a basic input/output system (BIOS) in read-only memory (ROM), such as ROM 908, for controlling the low-level operation of the device. The memory can also store an operating system in random-access memory (RAM) for controlling the operation of the device

Applications 910 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device 900 can optionally communicate with a base station (not shown) or directly with another computing device. One or more network interfaces in peripheral devices 912 are sometimes referred to as a transceiver, transceiving device, or network interface card (NIC).

An audio interface in Peripheral devices 912 produces and receives audio signals such as the sound of a human voice. For example, an audio interface may be coupled to a speaker and microphone (not shown) to enable telecommunication with others or generate an audio acknowledgment for some action. Displays in Peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 can comprise any input device arranged to receive input from a user. An illuminator in peripheral devices 912 can provide a status indication or provide light. The device can also comprise an input/output interface in peripheral devices 912 for communication with external devices, using communication technologies, such as USB, infrared, Bluetooth™, or the like. A haptic interface in peripheral devices 912 can provide a tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In some embodiments, a GPS receiver can determine the physical coordinates of the device via the Global Positioning System (GPS) receiver, GNSS (Global Navigation Satellite System), IEEE Precise Time Protocol (PTP), or other suitable timing reference and position protocol. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 9, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, from an application on a user equipment (UE) of a user, a request to provide an engagement score corresponding to a multi-party communication (MPC);
obtaining MPC data corresponding to the MPC, the MPC data including general MPC data and participant-specific MPC data;
determining the engagement score by applying a trained engagement score model to the general MPC data and the participant-specific MPC data; and
transmitting, to the UE, the engagement score to be displayed to the user through the application.

2. The method of claim 1, wherein the request further comprises a request to provide a visual representation of MPC keywords and wherein the method further comprises:
obtaining a text component of the MPC data;
parsing the text component to extract a first set of keywords, each keyword having a corresponding frequency;
removing any non-verb, non-noun keywords from the first set of keywords;
applying a keyword model to the first set of keywords to generate a second set of keywords;
ranking the second set of keywords based on frequency;
selecting predetermined number of top keywords from the second set of keywords to generate the MPC keywords;
generating a visual representation including the MPC keywords; and
transmitting, to the UE, the visual representation.

3. The method of claim 2, further comprising depicting, in the visual representation, each MPC keyword in a size corresponding to the MPC frequency and relative to the other MPC keywords.

4. The method of claim 1, wherein the trained engagement score model is a multi-class, regression-based machine learning (ML) model.

5. The method of claim 4, further comprising training the engagement score model by:
obtaining annotated MPC data for a plurality of MPCs;
clustering the MPCs based on the annotated MPC data, each cluster corresponding to an MPC type;
selecting a training dataset and a testing dataset from the clustered MPCs through stratified sampling;
training the engagement score model using the training dataset;
evaluating the engagement score model using the testing dataset based on target performance metrics selected from the group comprising: accuracy, precision, and recall; and
generating the trained engagement score model based on whether the engagement score model evaluation is acceptable.

6. The method of claim 1, wherein the request further comprises a request to provide MPC metrics selected from the group comprising a number of attendees, a number of moderators, and a length of the MPC.

7. The method of claim 1, wherein the general MPC data is selected from the group comprising a number of participants, dates and times associated with the MPC, an overall length, and a ratio of invited participants versus actual participants; and wherein the participant-specific MPC data is selected from the group comprising inbound/outbound audio timing, inbound/outbound video timing, inbound/outbound content timing, total inbound/outbound timing, total duration of participation, percentage of participation from overall MPC length, communications quality, and geographical location.

8. A non-transitory computer-readable storage medium for storing instructions executable by a processor, the instructions comprising:
receiving, from an application on a user equipment (UE) of a user, a request to provide an engagement score corresponding to a multi-party communication (MPC);
obtaining MPC data corresponding to the MPC, the MPC data including general MPC data and participant-specific MPC data;
determining the engagement score by applying a trained engagement score model to the general MPC data and the participant-specific MPC data; and
transmitting, to the UE, the engagement score to be displayed to the user through the application.

9. The non-transitory computer-readable storage medium of claim 8, wherein the request further comprises a request to provide a visual representation of MPC keywords and wherein the instructions further comprise:
obtaining a text component of the MPC data;
parsing the text component to extract a first set of keywords, each keyword having a corresponding frequency;
removing any non-verb, non-noun keywords from the first set of keywords;
applying a keyword model to the first set of keywords to generate a second set of keywords;
ranking the second set of keywords based on frequency;
selecting predetermined number of top keywords from the second set of keywords to generate the MPC keywords;
generating a visual representation including the MPC keywords; and
transmitting, to the UE, the visual representation.

10. The non-transitory computer-readable storage medium of claim 9, the instructions further comprising depicting, in the visual representation, each MPC keyword in a size corresponding to the MPC frequency and relative to the other MPC keywords.

11. The non-transitory computer-readable storage medium of claim 8, wherein the trained engagement score model is a multi-class, regression-based machine learning (ML) model.

12. The non-transitory computer-readable storage medium of claim 11, the instructions further comprising training the engagement score model by:
obtaining annotated MPC data for a plurality of MPCs;
clustering the MPCs based on the annotated MPC data, each cluster corresponding to an MPC type;
selecting a training dataset and a testing dataset from the clustered MPCs through stratified sampling;
training the engagement score model using the training dataset;
evaluating the engagement score model using the testing dataset based on target performance metrics selected from the group comprising: accuracy, precision, and recall; and
generating the trained engagement score model based on whether the engagement score model evaluation is acceptable.

13. The non-transitory computer-readable storage medium of claim 8, wherein the request further comprises a request to provide MPC metrics selected from the group comprising a number of attendees, a number of moderators, and a length of the MPC.

14. The non-transitory computer-readable storage medium of claim 8, wherein the general MPC data is selected from the group comprising a number of participants, dates and times associated with the MPC, an overall length, and a ratio of invited participants versus actual participants;
and wherein the participant-specific MPC data is selected from the group comprising inbound/outbound audio timing, inbound/outbound video timing, inbound/outbound content timing, total inbound/outbound timing, total duration of participation, percentage of participation from overall MPC length, communications quality, and geographical location.

15. A device comprising a processor configured to:
receive, from an application on a user equipment (UE) of a user, a request to provide an engagement score corresponding to a multi-party communication (MPC);
obtain MPC data corresponding to the MPC, the MPC data including general MPC data and participant-specific MPC data;
determine the engagement score by applying a trained engagement score model to the general MPC data and the participant-specific MPC data; and
transmit, to the UE, the engagement score to be displayed to the user through the application.

16. The device of claim 15, wherein the request further comprises a request to provide a visual representation of MPC keywords and wherein the processor is further configured to:
obtain a text component of the MPC data;
parse the text component to extract a first set of keywords, each keyword having a corresponding frequency;
remove any non-verb, non-noun keywords from the first set of keywords;
apply a keyword model to the first set of keywords to generate a second set of keywords;
rank the second set of keywords based on frequency;
select predetermined number of top keywords from the second set of keywords to generate the MPC keywords;
generate a visual representation including the MPC keywords; and
transmit, to the UE, the visual representation.

17. The device of claim 16, wherein the processor is further configured to depict, in the visual representation, each MPC keyword in a size corresponding to the MPC frequency and relative to the other MPC keywords.

18. The device of claim 15, wherein the trained engagement score model is a multi-class, regression-based machine learning (ML) model.

19. The device of claim 18, wherein the trained engagement score model is trained by:
obtaining annotated MPC data for a plurality of MPCs;
clustering the MPCs based on the annotated MPC data, each cluster corresponding to an MPC type;
selecting a training dataset and a testing dataset from the clustered MPCs through stratified sampling;
training the engagement score model using the training dataset;
evaluating the engagement score model using the testing dataset based on target performance metrics selected from the group comprising: accuracy, precision, and recall; and
generating the trained engagement score model based on whether the engagement score model evaluation is acceptable.

20. The device of claim 15, wherein the general MPC data is selected from the group comprising a number of participants, dates and times associated with the MPC, an overall length, and a ratio of invited participants versus actual participants; and wherein the participant-specific MPC data is selected from the group comprising inbound/outbound audio timing, inbound/outbound video timing, inbound/outbound content timing, total inbound/outbound timing, total duration of participation, percentage of participation from overall MPC length, communications quality, and geographical location.
